(19) United States
(12) Patent Application Publication
(10) Pub. No.: US 2001/0047251 A1
(43) Pub. Date: Nov. 29, 2001

(54) CAD system which designs 3-D models

(76) Inventor: William H. Kemp, Alexandria, VA (US)

Correspondence Address: Richard C. Litman, LITMAN LAW OFFICES, LTD., P.O. Box 15035, Arlington, VA, 22215, US

(21) Appl. No.: 09/796,896

(22) Filed: Mar. 2, 2001

Related U.S. Application Data
(60) Provisional application No. 60/186,756, filed on Mar. 3, 2000.

(51) Int. Cl. G06F 17/50

(52) U.S. Cl. 703/1

(57) ABSTRACT

The computer aided design (CAD) system for interactively designing three dimensional models for architectural projects operates on a client-server model in a distributed network, such as the Internet. The server first elicits general project information from the client, then prompts the client for detail project information through a scripting process, preferably using voice recognition software. As components are added to the project, an expert knowledge system reviews the model against heuristic rules and for conflicts with component manufacturer specifications and building codes. The server then creates a 3-D model. The client can take a virtual walk through of the model, making any desired revisions. Upon completion, the server provides the client with a 3-D CAD model, two dimensional CAD drawings in plan, elevation and section as desired, and completed construction schedule specifications, budget, and other documentation.

### CROSS-REFERENCE TO RELATED APPLICATION

This application claims the benefit of U.S. Provisional Patent Application Ser. No. 60/186,756, filed Mar. 3, 2000.

### BACKGROUND OF THE INVENTION

1. Field of the Invention

The present invention relates to computer aided design (CAD) techniques and, more particularly, to the use of intelligent symbolic three dimensional (3-D) component modeling in addition to a very user-friendly interface to achieve total design coordination that produces designs in a fraction of the time it currently takes.

2. Description of Related Art

The process of architectural, engineering, and interior design currently uses CAD equipment to automate the drafting process but does not directly aid in the design process. Building design is dependent on the coordination of thousands of objects across many design disciplines and usually involves multiple companies. These design objects are currently made of lines, arcs, circles, and written words that describe walls, floors, roofs, windows, doors, etc. Design coordination additionally involves state, national, and industry codes. The job of design coordination is a daunting task that now can only be done by human intelligence.

The related art is represented by the following patents of interest.

U.S. Pat. No. 4,965,741, issued on Oct. 23, 1990 to Michael A. Winchell et al., describes a method of interfacing a human user to an expert system operating in conjunction with computer aided design tools in the course of designing a complex integrated circuit product. U.S. Pat. No. 5,086,495, issued on Feb. 4, 1992 to Michael A. Gray et al., describes a solid modelling system for generating a spatial representation of an object defined in terms of solid geometric primitives combined by a logical expression including one or more combinatorial logical operators, which is adapted to recognize redundant primitives automatically.

U.S. Pat. No. 5,301,270, issued on Apr. 5, 1994 to Steven G. Steinberg et al., describes a computer-assisted software engineering system for facilitating the design, implementation, and execution of software applications in cooperative processing environments. U.S. Pat. No. 5,339,247, issued on Aug. 16, 1994 to Shigeki Kirihara et al., describes a distributed data CAD system which can effectively manage parts data while distributing the parts data of a number of related parts in a system where the total design is created by a plurality of separate workstations building separate parts.

U.S. Pat. No. 5,493,679, issued on Feb. 20, 1996 to Kenneth W. Virgil et al., describes a method for storing engineering drawings and artwork in a relational database for subsequent retrieval and use. U.S. Pat. No. 5,548,707, issued on Aug. 20, 1996 to Rene LoNegro et al., describes systems and methods for automatically creating a dimension indicator which defines the size of a geometric object or the spatial relationship between two geometric objects in CAD drawings.

U.S. Pat. No. 5,581,672, issued on Dec. 3, 1996 to John S. Letcher, Jr., describes a computer-aided geometric design environment which minimizes the effort required to revise and update geometric models, by capturing, storing, and utilizing essential dependencies between the model's geometric objects through a data structure which stores the name, numerical data and relationship of the geometric entity to other geometric entities. U.S. Pat. No. 5,586,052, issued on Dec. 17, 1996 to Mark P. Iannuzzi et al., describes a method and apparatus for inputting geometric data representing features of a manufactured part and tolerances for the features into a CAD program, and determining the adequacy of the part tolerances assigned by the designer of the part.

U.S. Pat. No. 5,745,751, issued on Apr. 28, 1998 to Robert W. Nelson et al., describes a method of creating a coordinate geometry based digital civil site information system model that defines with precision and accuracy each site entity by means of data reconciliation, input, and manipulation, and provides for updating the databases with new survey information. U.S. Pat. No. 5,761,674, issued on Jun. 2, 1998 to Kenji Ito, describes an integrated construction project management system which has a project model constructed by combining a product model that defines a product with the use of physical elements and functional elements, and a process model that defines activities related to the product, in order to provide communication of changes in the design of the project to other affected members of the construction project team.

U.S. Pat. No. 5,815,683, issued on Sep. 29, 1998 to Joe E. Volger, describes an access facilitator that is programmed to provide access service for facilitating remote client access to computer-aided design tools. U.S. Pat. No. 5,822,206, issued on Oct. 13, 1998 to Donald Sebastian et al., describes a computer-based engineering design system to design a part, a tool to make the part, and a process to make the part concurrently.

Japan Patent document 2-171860, published on Jul. 3, 1990, describes a computer aided design system to unitarily manage information used in a part table information management system, to unify a design part table and a manufacture part table, and to establish relation mutually between the tables by linking the constitution of plural parts with plural charts and executing sequential management.

A chapter entitled “AN INTERACTIVE DATA DICTIONARY FACILITY FOR CAD/CAM DATA BASES”, by Stephanie J. Cammarata et al., published in 1986 on pages 423-439 in a book entitled EXPERT DATABASE SYSTEMS by Benjamin Cummings, describes the design of a network-structured data base dictionary facility with an interactive graphical user interface for CAD/CAM data management.

None of the above inventions and patents, taken either singly or in combination, is seen to describe the instant invention as claimed.

### SUMMARY OF THE INVENTION

The computer aided design (CAD) system for interactively designing three dimensional models for architectural projects operates on a client-server model in a distributed network, such as the Internet. The server first elicits general project information from the client, then prompts the client for detail project information through a scripting process, preferably using voice recognition software. As components are added to the project, an expert knowledge system reviews the model against heuristic rules and for conflicts with component manufacturer specifications and building codes. The server then creates a 3-D model. The client can take a virtual walk through of the model, making any desired revisions. Upon completion, the server provides the client with a 3-D CAD model, two dimensional CAD drawings in plan, elevation and section as desired, and completed construction schedule, specifications, budget, and other documentation.

The CAD system is configured for use on a network, such as the Internet, an intranet, or an extranet. The CAD system includes a CAD server which contains novel software, hereinafter referred to as the Design Expert. Client terminals electrically connected with the network can selectively have access to the CAD server according to the CAD server criteria. These client terminals become clients of the CAD server in a client-server architecture. The number of client terminals is dependent on the number of users requiring access to the CAD server. The Design Expert includes three software modules including (1) a 3-D model creation using a question and answer session, (2) 3-D and 2-D model review and editing, and (3) a 3-D model conversion to 2-D finished drawings.

The first module provides the ability of the Design Expert to ask a series of questions and record verbal responses. Based on the answers given the CAD system continually reduces the decision options of all aspects of the design in a cascading fashion. When the system has enough answers (design criteria) the system will build and display a 3-D CAD model. The more design criteria the system has, the more elaborate the model becomes. When all questions are answered the 3-D model is complete. The estimated average design time for all disciplines is about 4-6 hours.

The second module enables the designer to explore and evaluate the model. The designer can evaluate the 3-D model by conducting a virtual walk-through. Measurements can be taken and 3-D elements can be inserted temporarily to evaluate scale and placement relationships. The designer can also ask the system for 2-D projections to be cut of the 3-D model in the form of floor plans, sections, and elevations. The designer can change model design criteria either on a global basis or locally and the model will change to suit the criteria. If there is a conflict in the design criteria, the system will display or describe the conflict and either ask for a resolution or suggest a solution. The system is built with heuristics knowledge of what objects are needed to create a building. This includes object relationships such as how objects are connected, how objects are oriented, object movement, object minimum and maximum dimensional size, code requirements (county, state, and national), model's geographic location and it's orientation to the sun, and financial budget requirements.

The third module provides the ability to convert the 3-D model into 2-D production drawings or construction documents. The system has the heuristic knowledge of what needs to be shown and how it needs to be represented. This includes architecture and all engineering discipline drawings including a cover sheet, an index sheet, a symbols and abbreviations sheet, a site plan, a life safety plan, a code review sheet, demolition details for floor plans, sections, and elevations, proposed construction details for floor plans, sections, and elevations, and schedule sheets. Once the 3-D model is complete the designer can extract specifications, a budget, and a schedule.

Accordingly, it is a principal object of the invention to provide a CAD system for interactively designing three dimensional models.

It is another object of the invention to provide an interactive CAD system for use on the Internet.

It is an object of the invention to provide improved elements and arrangements thereof in an interactive CAD system for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 shows a block diagram of a typical personal computer system which may be used by the client of server in the CAD system of the present invention.

FIG. 2 shows a block diagram of a network system which provides the operating environment for the CAD system of the present invention.

FIG. 3 is a block diagram showing the elements of the DEX server of the CAD system according to the present invention.

FIG. 4 is a block diagram outlining the initial scripting process for initiating a design project using the CAD system according to the present invention.

FIG. 5 is a block diagram outlining a typical client's offline data gathering process while using the CAD system according to the present invention.

FIGS. 6A-6B is a block diagram showing typical elements in a detailed project description process using the CAD system according to the present invention.

FIG. 7 shows a block diagram showing typical interaction between client and server in the CAD system according to the present invention.

FIGS. 8A,8B,8C,8D is a flow chart showing the process of using the CAD system for designing a 3-D model according to the present invention.

Similar reference characters denote corresponding features consistently throughout the attached drawings.

### DETAILED DESCRIPTION OF THE PREFERRED EMBODIMENTS

The present invention is a CAD system for interactively designing three dimensional models. The CAD system is configured for use on a network, such as the Internet, an intranet, or an extranet. The CAD system includes a CAD server which contains novel software in the form of a Design Expert (hereinafter referred to as the DEX server). Client computers electrically connected with the network can selectively have access to the CAD server according to the CAD server criteria. These client computers become clients of the CAD server in a client-server architecture. The number of client computers is dependent on the number of users requiring access to the CAD server.

The CAD system enables users to interactively design 3-D models. The Design Expert is a series of software modules that use artificial intelligence to work with CAD software to produce intelligent 2-D and 3-D models. The goal of the Design Expert is to allow a designer to define a design by using verbal descriptions of design criteria and pointing at design examples. Based on this question and answer session the computer will, in real-time and interactively, build a 3-D model of the design. The Design Expert is a system that uses a series of canned dialog questions and voice recognition to define design criteria for a variety of design problems.

The Design Expert converts the verbal design criteria into 3-D graphic representations and displays them on the client terminal's computer screen for the user to review and change at will. The Design Expert provides individuals with the freedom to build and explore a design without knowing how to use CAD. The Design Expert automatically coordinates all design conflicts including objects spatial orientation and movement, code compliance, multi-phase, and multi-discipline. The Design Expert automatically converts 3-D models into 2-D construction documents. The Design Expert automatically extracts specifications, budgets, and schedules. The Design Expert enables users to design and produce construction documents in hours for projects that normally take months to do.

The Design Expert includes three software modules including (1) a 3-D model creation using a question and answer session, (2) 3-D and 2-D model review and editing, and (3) a 3-D model conversion to 2-D finished drawings. The first module provides the ability of the Design Expert to ask a series of questions and record verbal responses. Based on the answers given the system continually reduces the decision options of all aspects of the design in a cascading fashion. When the system has enough answers (design criteria) the system will build and display a 3-D CAD model. The more design criteria the system has, the more elaborate the model becomes. When all questions are answered the 3-D model is complete. The estimated average design time for all disciplines is about 4-6 hours.

The second module enables the user to explore and evaluate the model. The user can evaluate the 3-D model by conducting a virtual walk-through. Measurements can be taken and 3-D elements can be inserted temporarily to evaluate scale and placement relationships. The user can also ask the system for 2-D projections to be cut of the 3-D model in the form of floor plans, sections, and elevations. The user can change model design criteria either on a global basis or locally and the model will change to suit the criteria. If there is a conflict in the design criteria, the system will display or describe the conflict and either ask for a resolution or suggest a solution. The system is built with heuristics knowledge of what objects are needed to create a building. This includes object relationships such as how objects are connected, how objects are oriented, object movement, object minimum and maximum dimensional size, code requirements (county, state, and national), model's geographic location and it's orientation to the sun, and financial budget requirements.

The third module provides the ability to convert the 3-D model into 2-D production drawings or construction documents. The system has the heuristic knowledge of what needs to be shown and how it needs to be represented. This includes architecture and all engineering discipline drawings including a cover sheet, an index sheet, a symbols and abbreviations sheet, a site plan, a life safety plan, a code review sheet, demolition details for floor plans, sections, and elevations, proposed construction details for floor plans, sections, and elevations, and schedule sheets. Once the 3-D model is complete the user can extract specifications, a budget, and a schedule.

The Design Expert is a revolutionary product that coordinates architectural/engineering design beyond any other product available. The Design Expert enables the user to quickly build and interact with their design because of an intelligent interface system that makes it transparent to the user.

The Internet comprises a large number of servers which are accessible by client computers, typically users of personal computers, through some private Internet access provider (such as Internet America) or an on-line service provider (such as America On-line, Prodigy, Compuserve, the Microsoft Network, and the like) Each of the client computers may run a browser, which is a known software tool used to access the servers via the access providers. A server operates a so-called web site which supports files in the form of documents and pages. A network path to a server is identified by a so-called Uniform Resource Locator or URL having a known syntax for defining a network connection.

The World Wide Web is that collection of servers of the Internet that utilize the Hypertext Transfer Protocol (HTTP). HTTP is a known application protocol that provides users access to files (which can be in different formats such as text, graphics, images, sound, video, etc.) using a standard page description language known as Hypertext Markup Language (HTML). HTML provides basic document formatting and allows the developer to specify links to other servers and files. Use of an HTML-compliant client browser involves specification of a link via the URL. Upon such specification, the client computer makes a transmission control protocol/Internet protocol (TCP/IP) request to the server identified in the link and receives a web page (namely, a document formatted according to HTML) in return.

A representative client computer has a system unit including a system bus or plurality of system buses to which various components are coupled and by which communication between the various components is accomplished. A microprocessor is connected to the system bus and is supported by read only memory (ROM) and random access memory (RAM) also connected to the system bus. The ROM contains among other code the Basic Input-Output system (BIOS) which controls basic hardware operations such as the interaction and the disk drives and the keyboard. The RAM is the main memory into which the operating system and application programs are loaded. A memory management chip is connected to the system bus and hard disk drive and floppy disk drive. A CD ROM, also connected to the system bus, is used to store a large amount of data, e.g a multimedia program or large database.

Also connected to the system bus are various input/output (I/O) controllers such as a keyboard controller, a mouse controller, a video controller, an audio controller, and the like. A keyboard controller provides a hardware interface for the keyboard. A mouse controller provides a hardware interface for the mouse (or other point and click device). A video controller provides a hardware interface for the display. An audio controller provides a hardware interface for multimedia speakers. A modem enables communication over a network to other computers over the computer network.

The operating system of the computer may be DOS, WINDOWS 3.x, WINDOWS '95, WINDOWS '98, OS/2, AIX, or other known and available operating systems. The RAM also supports a number of Internet access tools including, for example, an HTTP-compliant web browser. Known browser software includes Netscape, Netscape Navigator, Internet Explorer, and the like. The present invention is designed to operate within any of these known or developing web browsers. The RAM may also support other Internet services including simple mail transfer protocol or e-mail, file transfer protocol, network news transfer protocol or “Usenet”, and remote terminal access.

The CAD system enables a user to interactively create 3-D models on a computer network, such as the Internet. The user accesses the CAD system web site and is provided with options including the ability to temporarily utilize the CAD software to interactively create a 3-D model, in order for the user to experience the CAD system. The user also has the ability to obtain a CAD system account which authorizes the user to repeatedly obtain access to the CAD system server and be charged predetermined fee per designated time, such as $10 per hour, in accordance with conventional financial techniques. The CAD system determines a user password in conjunction with the user's desire to access the CAD system. Authorized CAD system users who wish to make use of the CAD system come to the CAD system web site and click on the relevant CAD system icon. When authorized CAD users click on access to the CAD system, the password is inquired. The user enters a password.

Depending on the password entered, the user is recognized as either an authorized user or a non-authorized user. If the user is recognized as an authorized user, the user can access the CAD system for the predetermined fee per time beginning at that time. If the user is recognized as a non-authorized user the user has entered a password which does not match the password memory, and the user is precluded from accessing the CAD system.

The CAD system enables users to interactively design 3-D models. 3-D model components are pre-made three dimensional graphic parametric objects that are the building blocks of the inventive CAD system. 3-D model components are accurate full-scale representations of products currently available in the market place. 3-D model components can be individual components such as a single 3⅝″ metal stud or they can be grouped assemblies of many components such as a wall system.

A building is made up of many types of components. Some are common to all types of buildings and some are unique to the function of the building such as a hospital. These components are grouped within different design disciplines. Some of these components interact with multiple disciplines. Architectural components include components such as wall assemblies (interior and exterior), floor assemblies, ceiling assemblies, roof assemblies, door assemblies, window assemblies, or the like. Interior design components include components such as furniture elements and assemblies, flooring systems, wall-covering systems, casework/millwork assemblies, lighting assemblies, drinking fountain assemblies, fire extinguisher assemblies, signage assemblies, bathroom assemblies, or the like. Structural engineering components include components such as column assemblies, beam assemblies, deck assemblies, roofing assemblies, foundation assemblies, or the like. Civil engineering components include components such as utility assemblies, electric duct bank assemblies, plumbing and piping system assemblies, electrical grounding system assemblies, or the like. There are landscaping systems such as cut and fill earthwork for water run-off, curb and gutter assemblies, roadwork assemblies, horticultural plants, horticultural watering assemblies, signage assemblies, or the like. Electrical engineering components include components such as power assemblies, grounding assemblies, lighting assemblies, data/communication assemblies, or the like. Mechanical engineering components include components such as ductwork assemblies, plumbing and piping assemblies, conditioning system assemblies, control system assemblies, or the like.

3-D model components have graphic and database characteristics that are essential for the integration with other elements:

(1) Boundary representation is the physical shape and size of a component in all three spatial dimensions. The boundary representation not only defines the exterior surface of the component but also the space within the component.

(2) Parametric properties allow components to change their shape and size within certain tolerances. The tolerances that restrict the parametric properties are manufacturing capabilities and availabilities, code requirements, and component manufacturing cost.

(3) Connection properties define how and where components are connected to other components.

(4) Orientation properties define how components are arranged in all three spatial dimensions. Several factors influence the orientation properties: gravity, construct ability, and operability.

(5) Movement properties define how components are intended to move in all three spatial dimensions. These may include radial sweep like a door, single axis slide like a window sash or multi-axis flex and bend like a structural element.

(6) Offset properties define the limits of components association. These may be defined by design heuristics or by code heuristics or both.

(7) Element name and description properties are labels that define the component and it's associated properties.

(8) Cost properties are momentary definitions of market values of components.

(9) Schedule lead time properties define the length of time required to deliver the components to the project for installation. This includes manufacturing and shipping times.

(10) Specification properties are written descriptions of a component and it's associated values.

Design dialog is a speech synthesis and voice recognition system that controls the design session by asking design criteria requirements and feeding back determined design values. The design dialog system is directed by a meta-knowledge (basic outline understanding) of the general requirements for constructing a building model. The design dialog system accesses design scripts and starts a design session by asking general design questions and, depending on the human responses, narrows the question subjects to specific design questions.

The following is an example of a typical design dialog:

Design Expert: Do you wish to design a new building or retrofit an existing building?

User: A new building.

Design Expert: What is the function of the building, i.e. commercial, residential, retail, hospital, etc.?

User: Commercial.

Design Expert: What is the address of the site?

User: 1100 K Street NW, Washington, D.C.

Design Expert: What is the budget?

User: 15 million dollars.

Design Expert: Does that include land cost?

User: No.

Design Expert: What is the date you wish to start construction?

User: Jul. 1, 2000.

Design Expert: How many floors do you want?

User: Ten.

Design Expert: What is your floor-to-floor dimension?

User: Fifteen feet.

Design Expert: How big are your column bays?

User: Thirty feet by thirty feet.

Design Expert: Please sketch a plan view of the floor plate.

User: The user sketches a polygon (no scale or dimension).

Design Expert: What is this overall dimension? (Highlights one axis of sketch)

User: 300 feet.

Design Expert: What is this overall dimension? (Highlights one axis of sketch)

User: 150 feet.

A three dimensional blocking model of the building appears on user's computer screen of the size and shape described thus far, the model is centered within the site property lines. The design dialog continues eventually asking all design disciplines to contribute.

Design dialog graphics are pre-made two or three dimensional graphic objects that represent components or component assemblies that the user can choose in a multiple-choice basis. These graphics appear in a separate display window as the Design Expert is verbally discussing the topic the graphics represent. For instance, the Design Expert may ask what kind of door type and frame type the user wishes to use throughout the building. The Design Expert would then show a variety of door types, different door sizes, different door styles, with or without windows within the door, etc. The user can then click on the images that represent the features he/she wants and the Design Expert would then assemble and place the appropriate graphics throughout the model where doors are indicated. This capability will be used for all components and component assemblies for all design disciplines.

Design heuristics are general ‘rules of thumb’ within each design discipline. Design heuristics are design constraints made up of rules that define how components or component assemblies interact and connect with other components or component assemblies. For instance, door hardware fits on a door within the requirements of the door hardware manufactures' specification, which requires a door frame that meets the requirements of the door hardware and the door, a door frame is inserted in a wall within a wall opening of a certain size and shape that is required for the door frame. This capability would be used for all components and component assemblies for all design disciplines. This would also include all cross discipline coordination.

Industry code heuristics are national, state, and local requirements for each design discipline that specifically define features for public safety. This may include, but is not exclusive to the American Disabilities Act, the National Fire Protection Code, the National Electric Code, etc. Industry codes are design constraints made up of rules that define how components or component assemblies interact and connect with other components or component assemblies. For instance, in order to assure safe passage in the event of a fire, corridor walls must be rated for one hour against fire and smoke. National codes take precedence State codes must either meet or perhaps exceed this precedence. Local codes may further define but not conflict with the national or state codes. This capability will be used for all components and component assemblies for all design disciplines. This will also include all cross discipline coordination.

Review functions include:

Graphic Model Review

3-D virtual viewing

3-D section viewing

3-D detail viewing

2-D plan viewing

2-D elevation viewing

2-D section viewing

2-D detail viewing (plan, elevation, and section)

Measurement Review

2-D linear distance calculations

point to point

perpendicular

area

3-D volume calculation

Associated Database Review

parts list

quantity

part type

manufacturer

location

budget

overall project

per building

per floor

per department

per room

per part

specifications

overall project

per discipline

cross discipline

per code requirements

schedule

overall project

per design discipline or contractor trade

Edit functions include:

(1) Individual component editing manipulates a single component through the use of Edit tools.

(2) Global component editing manipulates all components of a particular type through the use of Edit tools. The level of global editing can be controlled by project, building, floor, department, and room.

(3) Individual assembly editing manipulates a single assembly through the use of Edit tools.

(4) Global assembly editing manipulates all assemblies of a particular type through the use of Edit tools. The level of global editing can be controlled by project, building, floor, department, and room.

(5) Budget constraints editing manipulates either a single component or assembly or global components or assemblies by their unit purchase cost or their construct ability cost or both.

(6) Specifications constraints editing manipulates either a single component or assembly or global components or assemblies by their specification definition.

(7) Schedule constraints editing manipulates either a single component or assembly or global components or assemblies by their shipping and construct ability schedule.

(8) Boolean constraints editing manipulates either a single component or assembly or global components or assemblies by multiple edit functions at one time.

Edit tool function include replace/change, add, similar/like, delete, move, copy, mirror, rotate, and stretch/compress. Review and edit functions are available during the design session or after the design session has concluded.

Construction documents are a legal description of a project that is issued from the architects and engineers to the owner and contractors. Construction documents sealed and signed by licensed architects and engineers and establish legal responsibility for the integrity of a design. Construction documents are used for project construction pricing, contractor bidding, and project construction assembly. Construction documents include two dimensional drawings, specifications (description of components and their arrangement), project budget, and project schedule. While project budget and schedule are technically not part of the construction document because they are established at the beginning of the project and are subject to change throughout the design and construction phases of the project, they are included because they are given to the owner and the general contractor for construction administration purposes and are integral to the design and construction of the project.

The completed 3-D model is an accurate representation of the project but does not instruct the contractor on the “means and methods” direction for construction. Construction documents are instructions and descriptions of the components and their assembly with other components throughout the project. The drawings and specifications define the components by type, size, quantity, manufacture, and physical arrangement including measurements. The Design Expert uses heuristics to convert the 3-D model and it's database into a variety of drawings and specifications for each design discipline. The heuristics are rules that define how drawings are represented and how specifications are described. Design drawings generally include multiple images of the same areas but shown at different degrees of detail or spatial viewing. Design drawings include plan views, elevation views, section views, and detail views. Graphic elements of design drawings include two dimensional graphic representations of components, written descriptions or notes, measurement dimensions, and reference symbols.

The Design Expert is a web based product (business-to-business application service provider), no special hardware is required, minimal Internet traffic of data from client to server, broadband capabilities should not be assumed, web connection is required for host security/integrity, web site downloads necessary software to users system (evaporates after disconnect), client model is resident in client system for security, client's model can be reestablished to the Design Expert for design continuation unless manual manipulation by a client off-line has occurred, transparent user-friendly interface (speech recognition, graphic stretching/warping interpretation, multi-choice component selection, continuous interactive 3-D virtual graphic environment, continuous interactive requirements dialog, on-demand requirements history/editing, the Design Expert automatically converts 3-D information into 2-D representation for client review and analysis and measurements (continuous), intelligent component assembly per design sub-assembly (general predetermined requirements and defaults, user manipulated up to construct ability and code requirements), intelligent cross component assembly per design meta-assembly (general pre-determined requirements and defaults, user manipulated up to construct ability and code requirements).

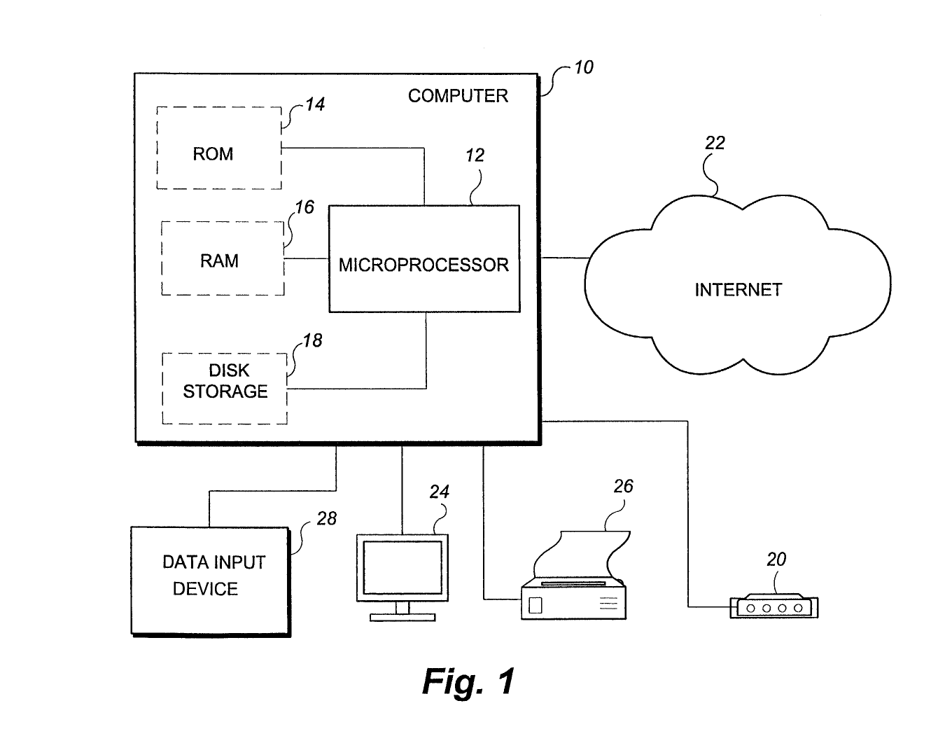

Turning now to the drawings, FIG. 1 illustrates a typical personal computer system which may be used on the client side or the server side of the CAD system. The personal computer system is a conventional system which includes a personal computer 10 having a microprocessor 12 (viz., an Intel Pentium III), including a central processing unit (CPU), a sequencer, and an arithmetic logic unit (ALU), connected by buses to an area of main memory for executing program code under the direction of the microprocessor 12, main memory including read only memory (ROM) 14 and random access memory (RAM) 16, the personal computer 10 also having disk storage 18, and preferably an internal modem 20 or other means for connecting to a network, such as Ethernet, ISDN, DSL, or other devices for connecting to a network 22, such as the Internet. The personal computer system also comprises peripheral devices, such as a display monitor 24, a printer 26, and one or more data input devices 28 such as a keyboard or mouse. It will be understood that the term disk storage 18 refers to a device or means for storing and retrieving data or program code on any computer readable medium, and includes a hard disk drive, a floppy drive or floppy disk, a compact disk drive or compact disk, a digital video disk (DVD) drive or DVD disk, a ZIP drive or ZIP disk, magnetic tape and any other magnetic medium, punch cards, paper tape, memory chips, or any other medium from which a computer can read. The personal computer 10 is connected to a network 22, preferably the Internet, accessed through a web browser executing in main memory.

The client computer system will have software executable in main memory, including a web browser and a CAD program linked to the web browser so that the client can receive and view CAD files from the server through a browser interface, and can also prepare a working sketch in CAD and send the sketch to the server through the network. It will be understood that the server side may comprise one or more processors or personal computers linked together in a rack or by a local area network (LAN) or wide area network (WAN), or it may be a microcomputer or mainframe having a processor and mass storage device. Because of the size of CAD drawing files and data transmission speeds, it is preferable that both the client and server be connected to the network through a dedicated, high speed transmission line, such as T1, DSL, ISDN, or the like.

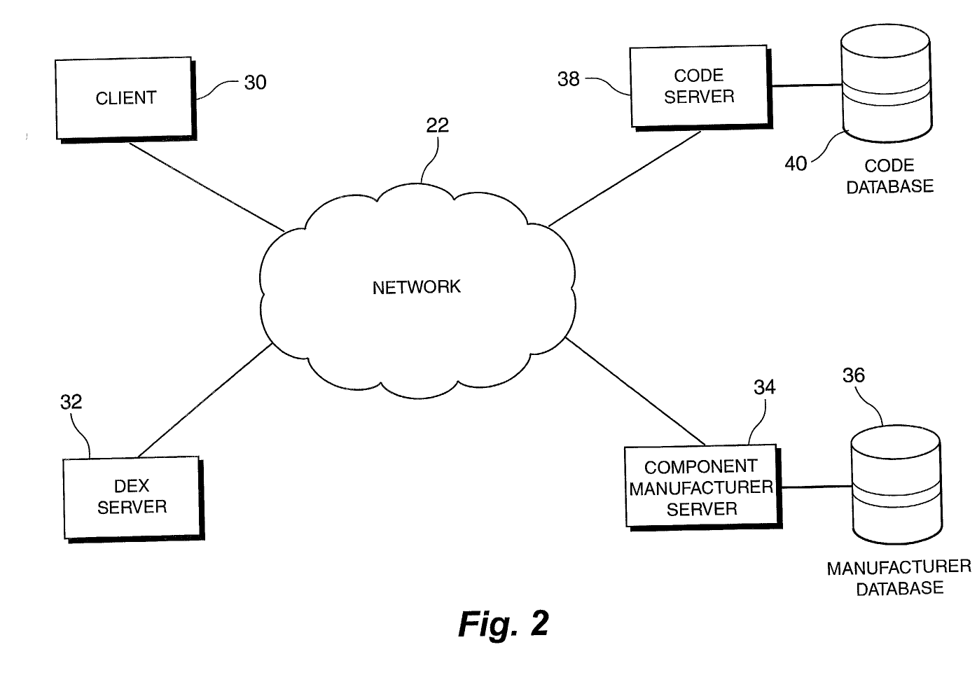

FIG. 2 shows a simplified block diagram of a typical network environment in which the CAD system operates. As shown, the client 30, also referred to as the user, and the DEX server 32 are connected to a network 22, which is preferably the Internet. Also connected to the Internet 22 are manufacturer servers 34 and code servers 38. The manufacturers are companies which manufacture components used in building construction, such as doors, windows, etc. The manufacturer's server will often provide photographs of the component produced which may be used in a visual menu of options presented to the client 30. Accessible through the manufacturers server 34 is the manufacturer's database 36, which contains information relating to their products, including specifications, cost, and a three dimensional drawing of the component.

The environment may or may not include code servers 38, which provided updated information on codes promulgating requirements for the construction industry, such as the BOCA (Building Officials and Code Administrators International, Inc.) Basic Building Code, the Uniform Building Code published by the International Conference of Building Officials, the National Building Code published by the American Insurance Association, the National Electrical Code (NEC), etc. When provided by a code server 38, code requirements are available through databases 40 accessible through the server 38. Alternatively, code requirements may be maintained on a system database accessible through the DEX server.

It will be understood that although the network 22 is preferably the Internet, in some cases the client and the DEX server may be connected to a LAN or WAN, which is, in turn, connected to the Internet. In any event, the client and server software is preferably web based, i.e., its interface is through hypertext markup language documents (HTML) which may be viewed through a web browser, such as Netscape Navigator or Microsoft Explorer, and is capable of sending and receiving Java and Extended Markup Language (XML) documents and forms.

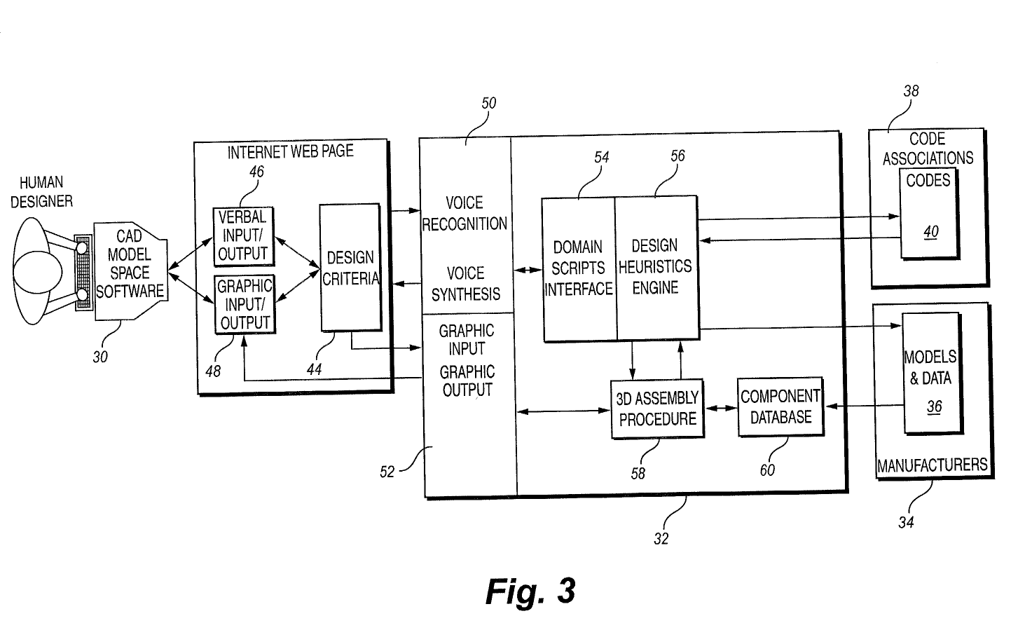

FIG. 3 shows a more detailed block diagram of the various components of the CAD system of the present invention. As mentioned previously, the client 30 computer has CAD modeling software operable thereon. The user interfaces the CAD system of the present invention through one or more web pages 42. The web pages 42 enable interactive communication of design criteria 44 through the medium of verbal input/output 46 using voice recognition software, and through graphic input/output 48 in the form of CAD drawings, photographs, and other graphic images, as well as traditional HTML, XML or Java based forms. The DEX server 32 has an HTML server, as well as hardware an software components for interfacing with the client 30 through voice recognition and voice synthesis 50 and graphic input/output 52.

The DEX server 30 uses domain scripts interfacing 54 for eliciting, receiving and interpreting data exchanged with the client 30. The scripting preferably includes voice recognition software, and may also be written with PERL, JavaScript, VBScript, or other languages. The data is evaluated with an expert knowledge system embodied in a design heuristics engine 56. The design heuristics engine 56 may interface through the network 22 with the manufacturer's server 34 and database 36, and with the code server 38 and database 40 as described above. The DEX server 30 also includes parametric modeling software for carrying out a 3-D assembly procedure 58 in conjunction with the design heuristics engine 56, and a component database 60 which may contain pictures of manufacturers components and references to their websites, as well as standard or stock components.

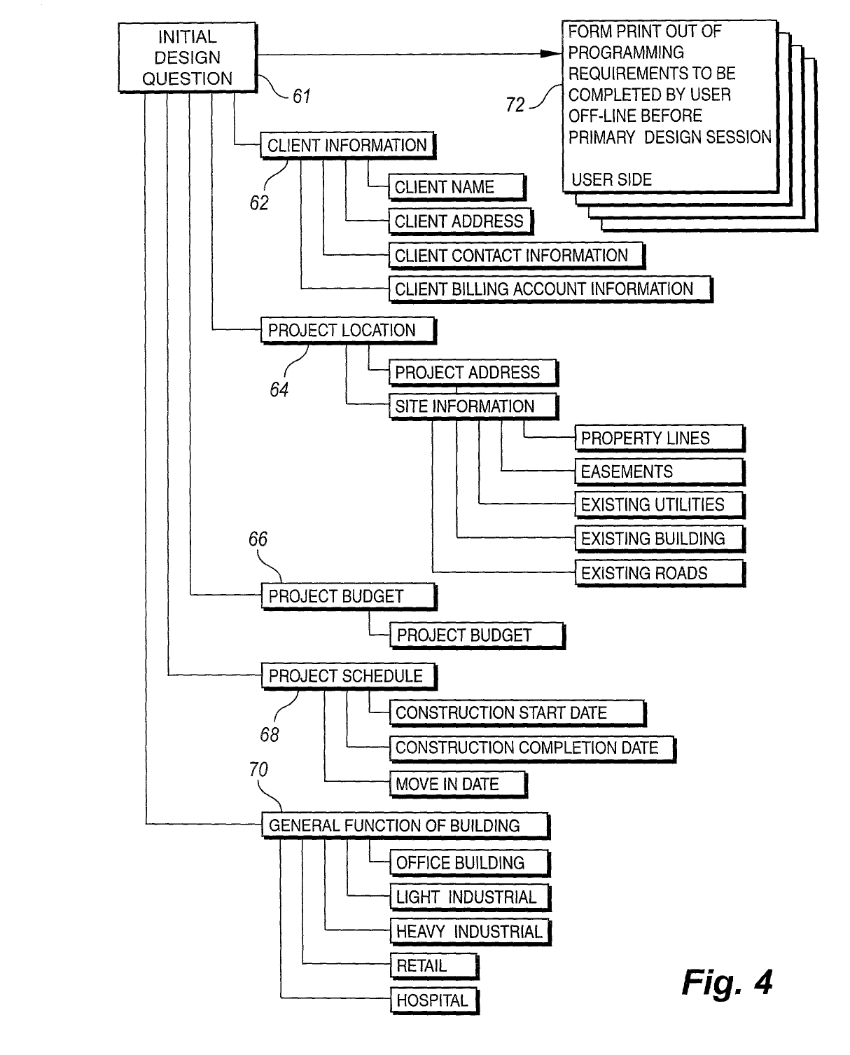

FIG. 4 is a block diagram illustrating typical initial project information the DEX server 32 requests the client 30 to furnish through initial design questions 61, and the DEX server's 32 response to the initial project information. By scripting prompts the server 32 asks the client 30 to furnish client information 62, including name, address, contact information, and billing account information; project location 64, including the project address and such site information as property lines, easements, existing utilities, any existing building, and existing roads; the project budget 66; the project schedule 68, including construction start date, construction completion date, and move in date; and the general function of the building 70, whether office building, light industrial, heavy industrial, retail, hospital, residential, etc. After receiving the information from the client 30, the DEX server 32 prepares and sends a detailed form with a set of programming requirements 72 to the client 30 via the network 22, so that the client 30 can gather the required information offline.

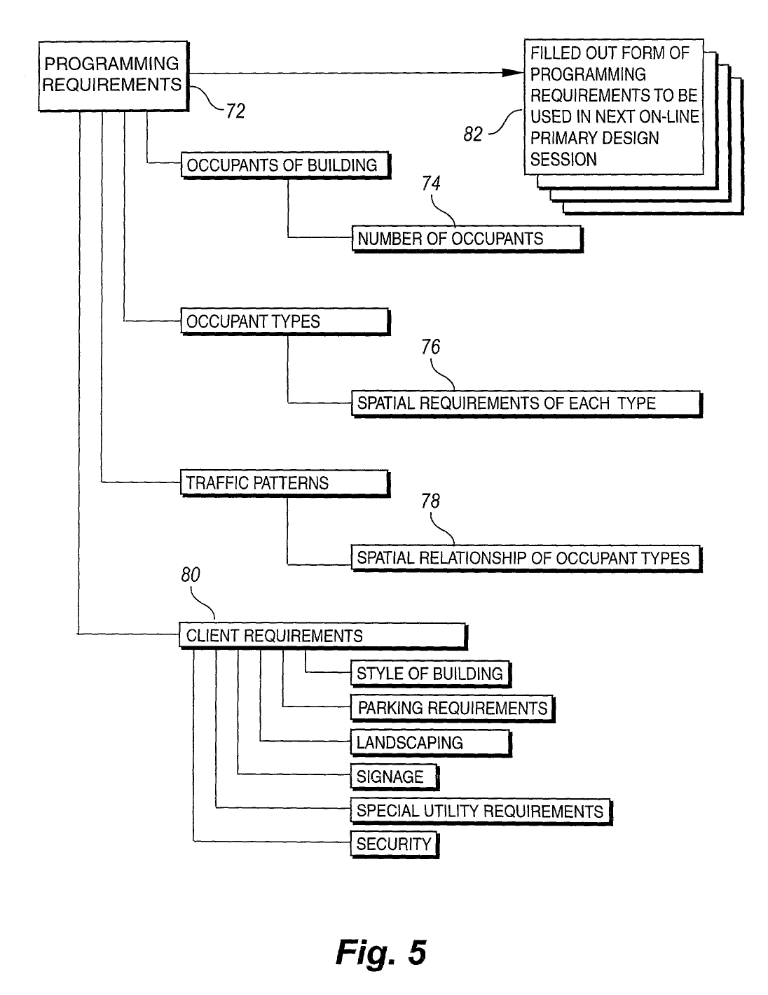

FIG. 5 illustrates the type of information that the client 30 will have to gather offline to prepare for the next scripting session. The programming requirements 72 will normally require that the client 30 be able to furnish detailed information regarding the occupants of the building, including the number of occupants 74, the type of occupants and their spatial requirements 76 in terms of volume of space and their traffic patterns or spatial relationship 78 to each other. In addition, the client 30 needs to be prepared to furnish details concerning client requirements 80, including the style of building, parking requirements, landscaping, signage, special utility requirements, and security needs. The client 30 fills out this information on the forms 82 sent by the DEX server 32 with these programming requirements 72 and is ready to proceed with the next scripting session with the server 32.

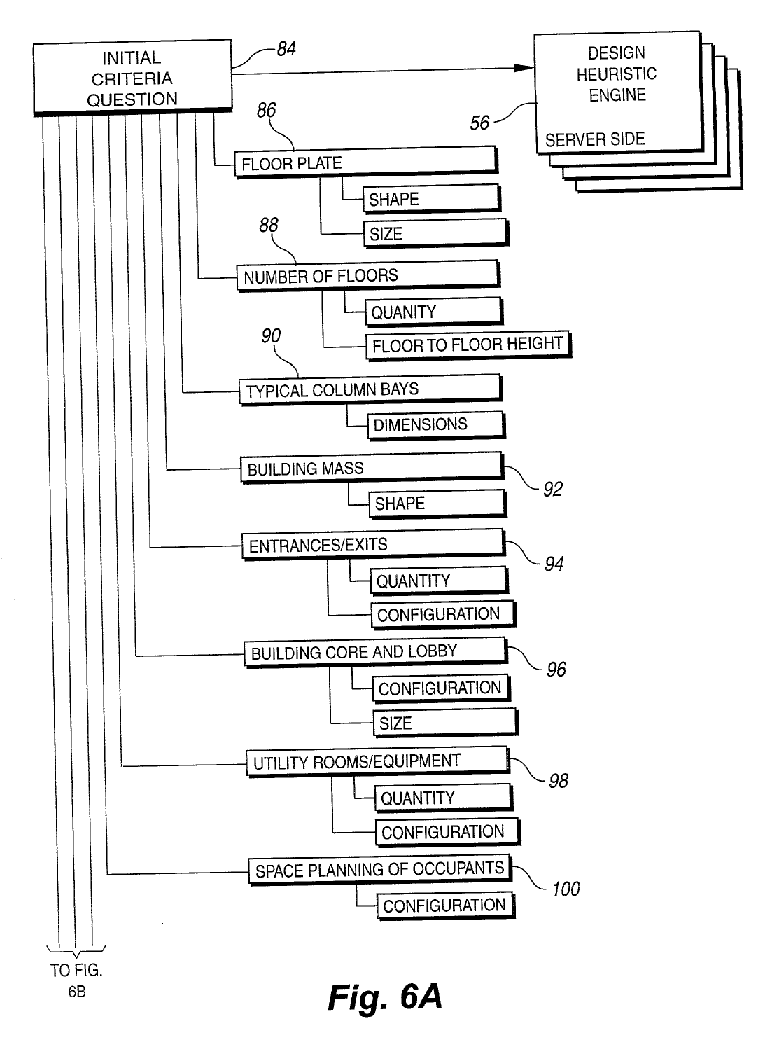

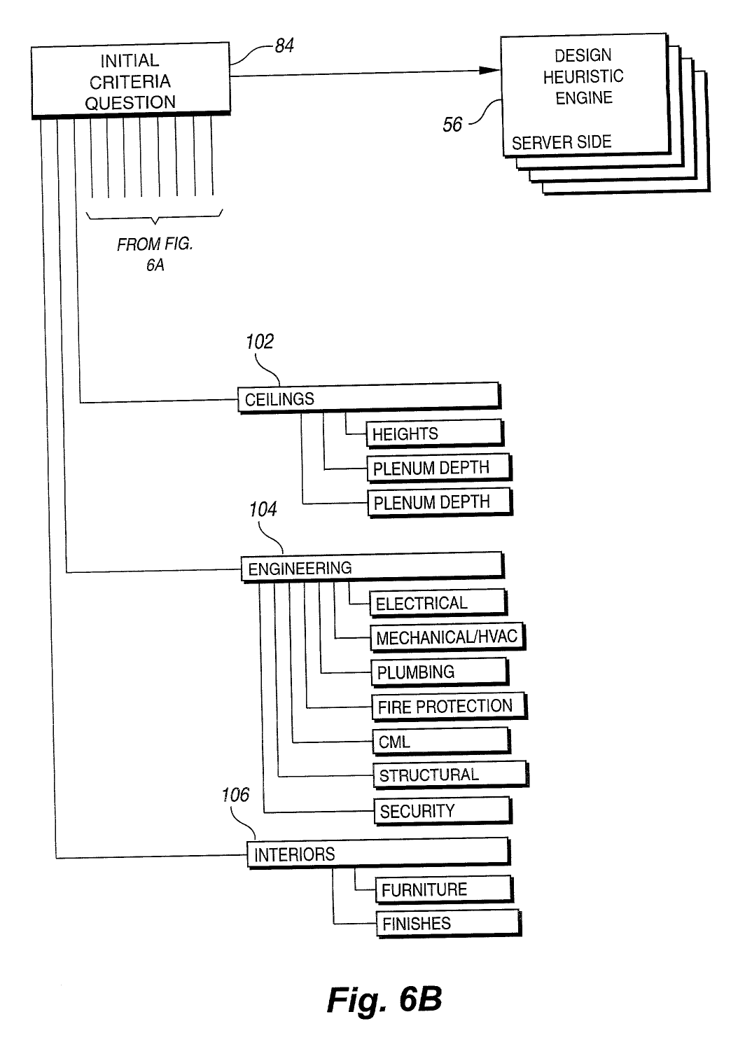

In the next scripting session, the DEX server 32 uses scripting language in the prompt and response format described above to obtain sufficient responses to design criteria questions 84 so that the DEX server 32 has may prepare a 3-D CAD drawing representing the project, as illustrated in FIGS. 6A-B. The design criteria questions cover such matters as: the floor plate 86, including size and shape; the number of floors 88, including both the quantity and floor to floor height; the dimensions of typical column bays 90; the building mass and shape 92; the quantity and configuration of entrances and exits 94; the configuration and size of the building core and lobby 96; the quantity and configuration of utility rooms and equipment 98; the configuration of space planning of the building occupants 100; the heights, plenum depth, and types of ceilings 102; various specialty engineering requirements 104, such as electrical, mechanical and Heating, ventilation and air conditioning (HVAC), plumbing, fire protection, civil engineering, structural engineering; and security; and interior design features 106, such as furniture and finishes.

It will be understood that some of the information requested by the DEX server 32 can be supplied be verbal responses with voice synthesis and voice recognition software, or by traditional web based forms. However, the DEX server 32 may also prompt the client 30 to provide a working sketch using CAD software of a component of the building, e.g., a wall or a floor plan. Upon receiving the sketch, the DEX server 32 may sequentially highlight a portion of the component, such as the length, width, or height of the component and ask the client 30 to provide the dimension of the highlighted portion, so that the process is interactive and takes advantage of the visual and intuitive opportunities offered by the medium of a computer network having a graphical interface. The client's responses to the design criteria questions 84 are transmitted to the DEX server 32 via the network 22, where they are evaluated by the design heuristic engine 56.

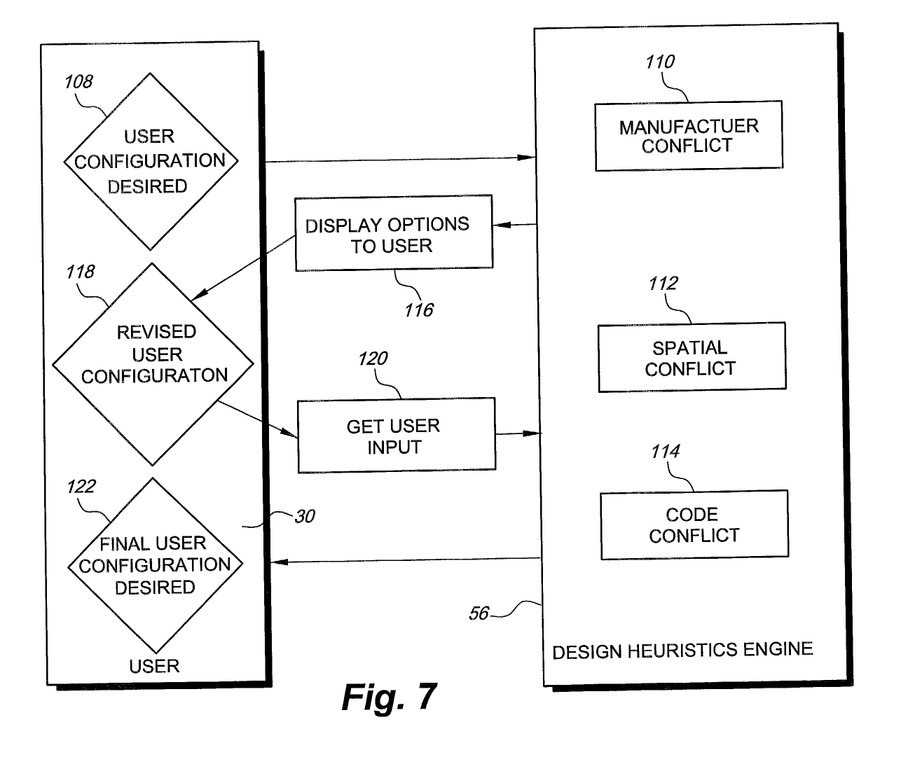

The interaction between the client 30, or user, are graphically portrayed in FIG. 7. The responses to the design criteria questions 84 provide the DEX server 32 with the user's desired configuration 108. This user desired configuration 108 is communicated to the DEX server 32 via the network 22, where the configuration 108 is evaluated by the design heuristics engine 56. The expert knowledge software evaluates the configuration 108 for conflicts with manufacturer's specification 110, spatial conflict 112 and conflict with various codes 114. Where the user 30 has options, the design heuristics engine 56 displays those options 116 to the user 30, resulting in a revised user configuration 118. The revised user configuration 118 is communicated to the DEX server 32, which gets the user input 120 and prepares and communicates the final user configuration 122 to the client.

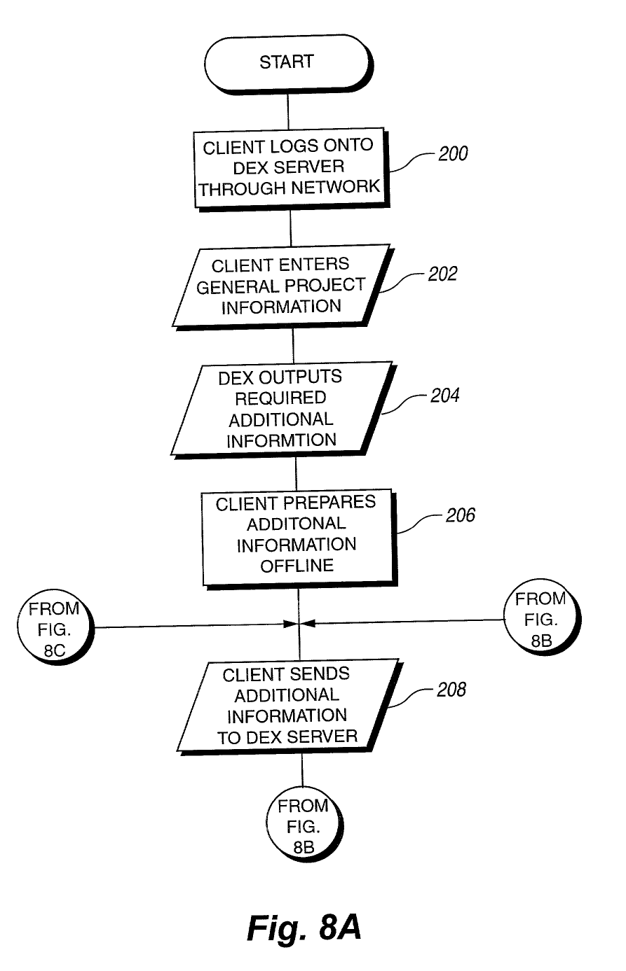

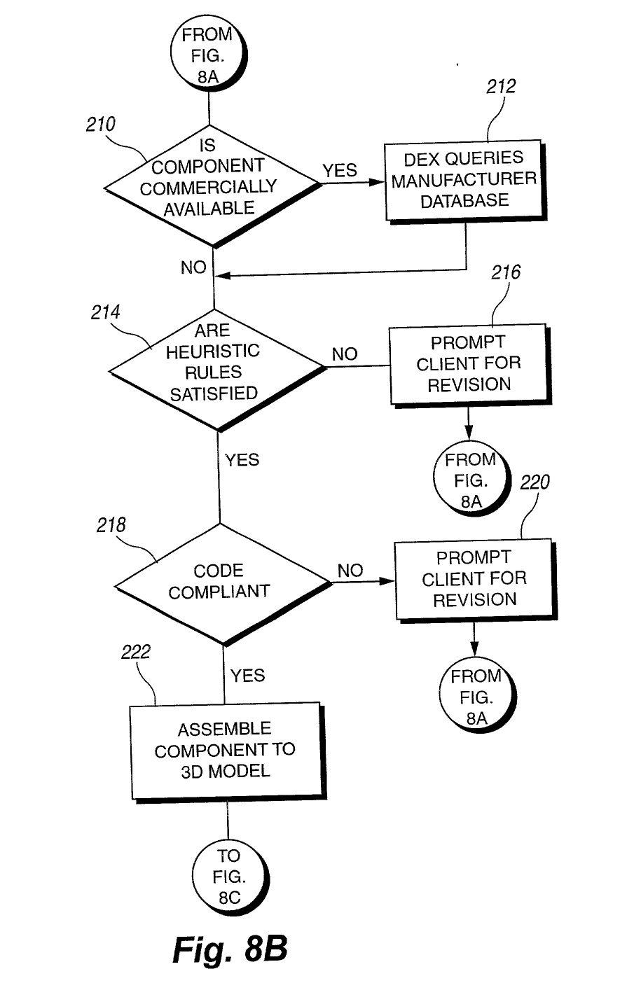

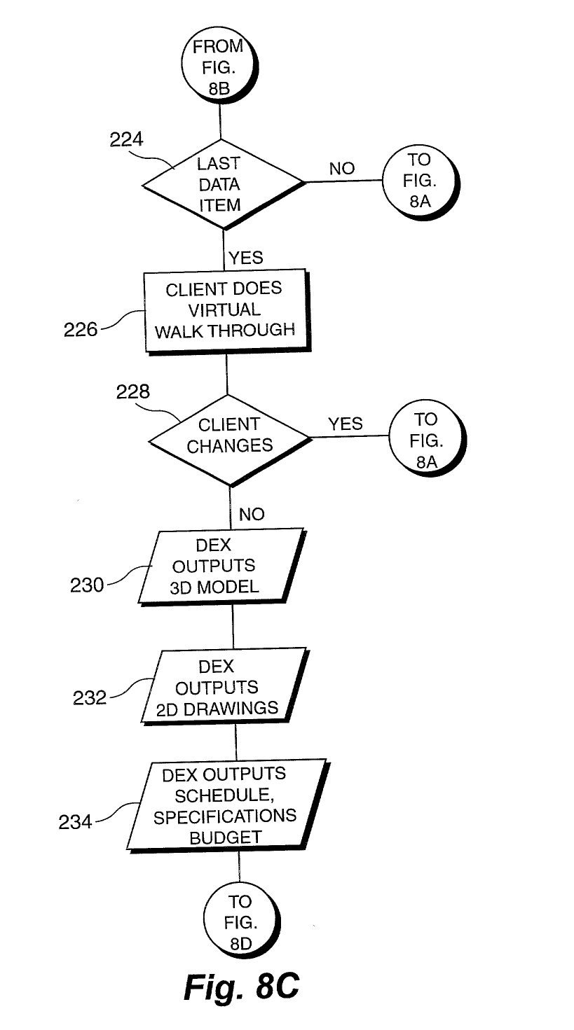

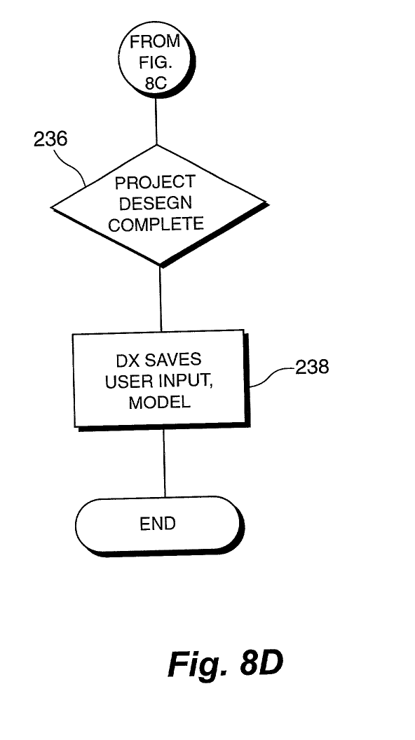

FIGS. 8A-8D show the overall process of using the CAD system to design a 3-D model. The process begins at step 200 when the client 30 logs in on the DEX server 32 through the network 22, preferably the Internet. A variety of login procedures are conventionally available, so that the login procedure will not be described in detail. At step 202, the client 30 enters general project information in response to the DEX server 32 prompts, as described above with reference to FIG. 4. The DEX server 32 evaluates the information provided using a scripting language, and outputs a form of additional programming requirement 72 information at step 204, which the client 30 prepares offline at step 206, as described above with respect to FIG. 5.

At the next session with the DEX server 32, the client 30 inputs the type of detailed information discussed with reference to FIG. 6 above at step 208. As each additional component is added by the client 30 to supply another design criteria, the DEX server 32 checks to see if the client 30 is adding manufactured component 210, presenting a visual menu of options to the client 30 where appropriate, and obtaining specifications and a 3-D model of the component from the manufacturer's database 212. The DEX server 32 uses the design heuristic engine 56 and expert knowledge software to test whether heuristic rules well known in the construction industry are being complied with 214. If not, the client 30 is prompted for a revision 216 and steps 208-214 are repeated, otherwise the DEX server 32 checks for compliance with the appropriate building and safety codes 218. If the component or structure with the component is not added, the client 30 is prompted for a revision 220 and steps 208-218 are repeated.

Otherwise the DEX server 32 assembles the component to the 3-D model 222 using conventional parametric modeling software and techniques. If the component is not the last item, as tested as step 224,in the design criteria questions 84, steps 208-222 are repeated for the next component called for by the design criteria questions 84. Once the last design criteria has been supplied, the 3-D model is complete and the model may be reviewed by the client 30 by a variety of techniques, including a virtual walk-through 226. Several conventional programming techniques may be applied during the review process, including the application of object view filters. The model may be filtered by trade discipline, i.e., electrical, plumbing, masonry, etc.; by design discipline (architectural, interior design, etc.); by floor level; by department; by room number or name; by occupant name; by bay; and by material, among others. Visual enhancement techniques allow the walk through to use either a 3-D virtual mode or 2-D projections (plan views, section views, detail views, etc.).

If the client 30 has changes at the walk-through 228, steps 208-226 are repeated. Otherwise, the DEX server finalizes the 3-D model using the design heuristic engine 56 and assembly procedure 58 and outputs the 3-D CAD model at step 230 to the client 30 using conventional web based file transfer protocols. The DEX server 32 also assembles and outputs a set of 2-D CAD projections for the project 232 to the client 30, as needed or appropriate or requested by the client 30. The DEX server 32 uses the design heuristic engine 56 and conventional software to assemble additional project documentation 234 based upon the 3-D model and information stored either permanently or temporarily for the project at hand, such as construction schedules, material specifications, project budget, safety plans, etc. The DEX server 32 saves the user input and the model 238 until the next session.

All communications or file transfers between the DEX server 32 and the client 30 may be made using conventional encryption techniques or other means for secure data transfer.

It will be understood that although the foregoing description is particularly directed to architectural projects, it will be obvious to those skilled in the art that the principles of the present invention are also applicable to a system for providing 3-D CAD models for articles of manufacture, chemical compounds and the like.

It is to be understood that the present invention is not limited to the sole embodiments described above, but encompasses any and all embodiments within the scope of the following claims.

I claim:

1. A computer aided design system for interactively designing three dimensional models in a computer network, said computer aided design system comprising:
(a) a computer aided design server computer having a processor, a main memory, and a mass storage device connected by a bus;
(b) a data communication device connecting said server computer to a computer network;
(c) software program code stored on said server computer and executable by the processor, including:
(i) web based software means for publishing a web site on the computer network accessible to client computers;
(ii) scripting software code means for obtaining project data from a client computer over the network;
(iii) expert knowledge software means for evaluating the project data for compliance with heuristic rules and communicating a conflict to a client computer;
(iv) 3-D assembly software means for preparing a three dimensional computer aided design model based on the project data; and
(v) file transfer protocol means for transferring the three dimensional model to the client computer.

2. The computer aided design system according to claim 1, wherein said software program code further comprises software code means for providing 3-D and 2-D model review and editing of the three dimensional model by a client computer.

3. The computer aided design system according to claim 1, wherein said software program code further comprises software code means for providing 3-D model conversion to two dimensional computer aided design finished drawings.

4. The computer aided design system according to claim 1, wherein said expert knowledge software means comprises heuristic rules for architectural models.

5. The computer aided design system according to claim 1, further comprising at least one client computer having:
(a) a processor, a main memory, and a mass storage device connected by a bus;
(b) a data communication device connecting said client computer to the computer network;
(c) software program code stored on said client computer and executable by the processor, including software means for drawing and viewing computer aided design drawings linked to a web browser.

6. The computer aided design system according to claim 1, wherein said scripting software code means further comprises voice recognition software code and voice synthesis software code.

7. The computer aided design system according to claim 1, wherein said software program code further comprises software code means for obtaining component data, including a three dimensional CAD drawing of the component, from a manufacturer's database, and for presenting a graphical menu of optional components to a client computer.

8. The computer aided design system according to claim 1, wherein said expert knowledge software means further comprises means for evaluating the project data for compliance with manufacturer's specifications and communicating a conflict to a client computer.

9. The computer aided design system according to claim 1, wherein said expert knowledge software means further comprises means for evaluating the project data for compliance with building codes and communicating a conflict to a client computer.

10. The computer aided design system according to claim 1, wherein said software program code further comprises software code means for providing a client computer with a virtual walk-through of the three dimensional model.

11. A computer program product that includes a medium readable by a processor, the medium having stored thereon a set of instructions for designing three dimensional models in a computer network, comprising:
(a) a first sequence of instructions which, when executed by the processor, causes said processor to publish a web site on the computer network accessible to client computers;
(b) a second sequence of instructions which, when executed by the processor, causes said processor to obtain project data from a client computer over the network;
(c) a third sequence of instructions which, when executed by the processor, causes said processor to use expert knowledge for evaluating the project data for compliance with heuristic rules and to communicate a conflict to a client computer;
(d) a fourth sequence of instructions which, when executed by the processor, causes said processor to prepare a three dimensional computer aided design model based on the project data; and
(e) a fifth sequence of instructions which, when executed by the processor, causes said processor to transfer the three dimensional model to the client computer.

12. The computer program product according to claim 11, further comprising a sixth sequence of instructions which, when executed by the processor, causes said processor to provide a client computer with a virtual walk-through of the three dimensional model.

13. The computer program product according to claim 11, further comprising a sixth sequence of instructions which, when executed by the processor, causes said processor to provide a set of two dimensional computer aided design finished drawings representing two dimensional views of the three dimensional model.

14. The computer program product according to claim 11, further comprising a sixth sequence of instructions which, when executed by the processor, causes said processor to prompt a client computer for project data by using voice synthesis and to receive and interpret the client computer's responses by using voice recognition.

15. In a computer network having a computer aided design server computer connected to the network and at least one client computer connected to the network, a method for interactively designing three dimensional models on the server computer, comprising the steps of:
(a) publishing a web site on the network;
(b) logging a client computer into the web site;
(c) prompting the client computer to provide an item of project data;
(d) receiving the item of project data from the client computer;
(e) evaluating the item of project data for compliance with heuristic design rules and notifying the client computer of any conflict with the heuristic design rules;
(f) assembling the project data into a three dimensional computer aided design model;
(g) evaluating the three dimensional computer aided design model for compliance with heuristic design rules and notifying the client computer of any conflict with the heuristic design rules;
(h) repeating steps (c) through (g) until all items of project data have been received, evaluated, and assembled;
(i) assembling a file containing a finalized version of the three dimensional computer aided design model; and
(j) transferring the file to the client computer.

16. The method of interactively designing three dimensional models according to claim 15, further comprising the step of presenting the three dimensional computer aided design model to the client computer in at least one web page for review before step (i).

17. The method of interactively designing three dimensional models according to claim 16, further comprising the steps of receiving revised project data from the client computer and revising the three dimensional computer aided design model before step (i).

18. The method of interactively designing three dimensional models according to claim 15, further comprising the steps of preparing a set of two dimensional computer aided design finished drawings representing two dimensional views of the three dimensional model and transferring the drawings to the client computer.

19. The method of interactively designing three dimensional models according to claim 15, further comprising the steps of:
(a) obtaining component data for and a three dimensional computer aided design drawing of any pre-manufactured components from a manufacturer's database over the computer network;
(b) presenting a graphical menu of premanufactured components to the client computer;
(c) evaluating the project data for compliance with the component data provided by the manufacturer and the heuristic design rules; and
(d) incorporating the three dimensional drawing of the component provided by the manufacturer into the three dimensional computer aided design model of the project.

20. The method of interactively designing three dimensional models according to claim 15, further comprising the step of evaluating the project data for compliance with any applicable building codes.
